(19) United States
(12) Patent Application Publication
(10) Pub. No.: US 2026/0082408 A1
(43) Pub. Date: Mar. 19, 2026

(54) UE CAPABILITY SIGNALING FOR NON-CAUSAL DMRS COMBINING ACROSS SLOTS

(71) Applicant: QUALCOMM Incorporated, San Diego, CA (US)

(72) Inventors: Somsubhra BARIK, San Diego, CA (US); Jing SUN, San Diego, CA (US)

(21) Appl. No.: 18/884,987

(22) Filed: Sep. 13, 2024

(51) Int. Cl. H04W 72/51; H04L 5/00; H04L 25/02; H04W 72/20; H04W 76/20; H04W 80/02

(52) U.S. Cl. CPC H04W 72/51; H04L 5/0051; H04L 25/0202; H04W 72/20; H04W 76/20; H04W 80/02

(57) ABSTRACT

A first device transmits an indication of capability information of the first device to support data storage associated with non-causal demodulation reference signal (DMRS) combining across multiple slots. The first device receives a communication after transmission of the indication of the capability information.

### TECHNICAL FIELD

The present disclosure relates generally to communication systems, and more particularly, to wireless communication including demodulation reference signal (DMRS) combining.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a first device. The apparatus transmits an indication of capability of a first device to support data storage associated with non-causal demodulation reference signal (DMRS) combining across multiple slots; and receives a communication after providing the indication of the capability information. For example, non-causal DMRS combining refers to one-shot channel estimation in a given slot using DMRS symbols from the current slot and/or subsequent slots.

In an aspect of the disclosure, a method, a computer-readable medium, and an apparatus are provided for wireless communication at a second device. The apparatus obtains an indication of capability of a first device to support data storage associated with non-causal DMRS combining across multiple slots; and provides a communication for the first device after reception of the capability information. For example, non-causal DMRS combining refers to one-shot channel estimation in a given slot using DMRS symbols from the current slot and/or subsequent slots.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4 illustrates an example of causal demodulation reference signal (DMRS) combining and non-causal DMRS combining, in accordance with various aspects of the present disclosure.

FIG. 5 illustrates an example of non-causal DMRS combining, in accordance with various aspects of the present disclosure.

FIG. 6 illustrates an example communication flow between a first wireless device and a second wireless device, in accordance with various aspects of the present disclosure.

FIG. 7 illustrates an example in which a later transmission time interval (TTI) does not include a front loaded DMRS in connection with non-causal DMRS combining, in accordance with various aspects of the present disclosure.

FIG. 8 illustrates an example of feedback timing with and with and without DMRS combining, in accordance with various aspects of the present disclosure.

FIG. 9 illustrates an example of feedback timing and control information decoding delay with and without DMRS combining, in accordance with various aspects of the present disclosure.

FIG. 10 illustrates an example of a change in buffer capability (or capacity) based on changes in carriers or BWPs.

FIG. 11 illustrates examples of different numbers of total DMRS for non-causal DMRS combining, in accordance with various aspects of the present disclosure.

FIG. 12 is a flowchart of a method of wireless communication at a first device, in accordance with various aspects of the present disclosure.

FIG. 13 is a flowchart of a method of wireless communication at a second device, in accordance with various aspects of the present disclosure.

FIG. 14 is a diagram illustrating an example of a hardware implementation for an example apparatus and/or UE, in accordance with various aspects of the present disclosure.

FIG. 15 is a diagram illustrating an example of a hardware implementation for an example network entity, in accordance with various aspects of the present disclosure.

### DETAILED DESCRIPTION

In some aspects, a receiver (or first wireless device) can combine multiple demodulation reference signals (DMRSs). In some examples, the receiver can combine DMRS symbols across transmission time intervals (TTIs). The combined DMRS may provide a refined channel estimation that can be used to improve demodulation of the received data. The data may be downlink data, uplink data, or sidelink data. For example, a user equipment (UE) can use a refined channel estimation based on a combination of DMRS symbols across TTIs to improve demodulation of a received physical downlink shared channel (PDSCH) transmission. As another example, a network node, such as a base station may demodulate a received physical uplink shared channel (PUSCH) transmission based on a combination of DMRSs. As another example, a UE may demodulate a received physical sidelink shared channel (PSSCH) based on a combination of DMRSs. The combining of DMRSs across multiple TTIs (e.g., multiple slots) may be referred to as DMRS combining and/or DMRS bundling.

In causal DMRS combining, a receiving device receives and decodes data in a first TTI (e.g., a first slot) based on channel estimation using DMRS received in the first TTI. For later TTIs (e.g., subsequent slots), the receiving device uses a joint channel estimation based on DMRS received in the first TTI and the later TTI in order to obtain a more refined channel estimation for decoding data in the later TTI. In contrast to the causal DMRS combining, in which the joint channel estimation is used for decoding data in later TTIs, for non-causal DMRS combining the receiving device buffers the data received in the first TTI until the joint channel estimation is performed based on a combination of DMRS symbols, e.g., combined across multiple TTIs. Then, after performing the joint channel estimation across the multiple TTIs, the UE decodes the buffered data in the first TTI. In some aspects, non-causal DMRS combining may also be referred to as “one-shot channel estimation.” For example, the data transmission (e.g., PDSCH, PUSCH, or PSSCH) received in a slot n is buffered until a combined channel estimation is performed based on the DMRS in slot n combined with the DMRS in slot n+1. The non-causal combining of DMRS symbols across TTIs (e.g., one-shot channel estimation across TTIs) can help to avoid lengthy extrapolation in channel estimation based on front loaded DMRS symbols in a slot. The non-causal DMRS combining may also improve channel estimation performance of initial slots in traffic bursts, e.g., which may not be in a position that enables combining with prior TTIs.

As presented herein, a first device (which may be a UE or a network node) may signal support for a capability to store data (e.g., PDSCH data, PUSCH data, or PSSCH data) for DMRS combining across slots in a non-causal manner (e.g., where the first device buffers the data until the channel estimation based on the combination of DMRS symbols across multiple TTIs).

For example, capability signaling aspects are presented for non-causal DMRS bundling to start processing data tones after multiple DMRS symbols (e.g. across current and multiple subsequent slots) are received and channel estimation is done jointly. Aspects are presented about what to report and how to report the capability related to buffer size and number resources, among other example aspects.

In some aspects, a first device transmits an indication of a maximum amount of data storage that the first device supports for combining across multiple slots associated with non-causal DMRS combining. The first device then receives communication after providing the indication of the maximum amount of the data storage that the first device supports. The communication may be scheduled based on the capability information indicated to a second device. In some aspects, the first device may be a UE, and the second device may be a network node such as a base station. In some aspects, the first device may be a base station, and the second device may be a UE. In some aspects, the first device may be a first UE, and the second device may be a second UE.

Particular aspects of the subject matter described in this disclosure can be implemented to realize one or more of the following potential advantages. In some examples, by providing information about data buffering capabilities, processing timelines, and/or BWP or CC combination information, the described techniques can be used to improve scheduling for a first device to improve data reception through DMRS bundling while also taking into account the first device's particular capabilities relating to the DMRS bundling. The aspects can improve scheduling of data transmissions by matching the data transmission and accompanying DMRS to the capabilities supported by the first device in connection with non-causal DMRS bundling.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

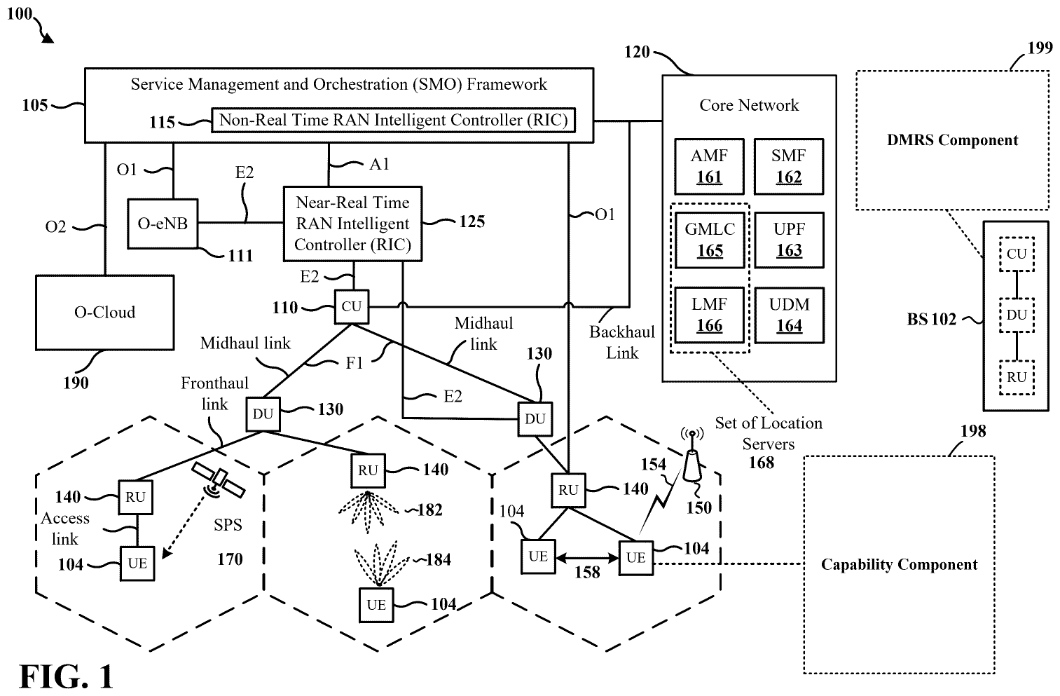

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a capability component 198 that may be configured to transmit an indication of capability of the UE to support data storage associated with non-causal DMRS combining across multiple slots and receive a communication after providing the capability information.

In certain aspects, a network node, such as the base station 102 or one or more components of the base station 102, may have a DMRS component 199 that may be configured to obtain an indication of capability of a UE to support data storage associated with non-causal DMRS combining across multiple slots and provide a communication for the UE after receiving the capability information.

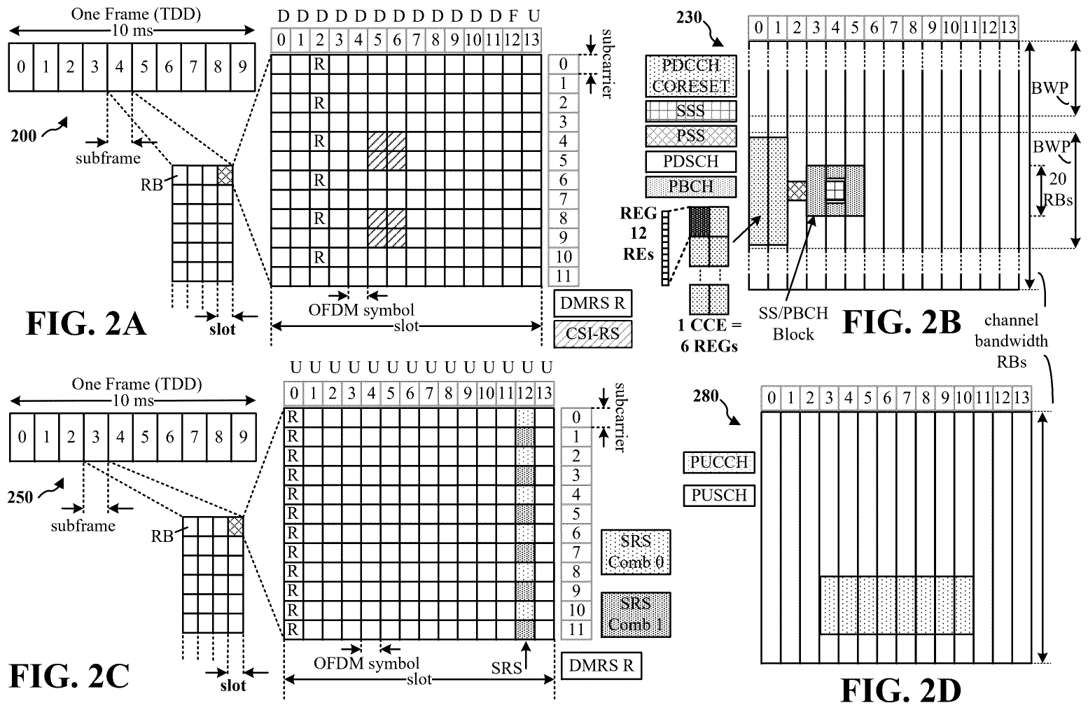

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

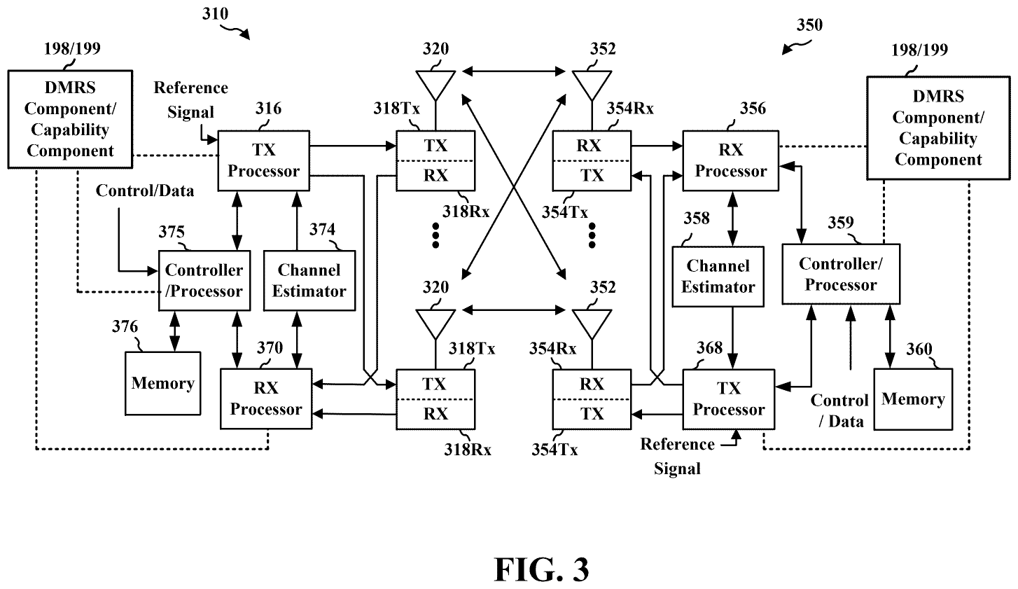

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the capability component 198 and/or the DMRS component 199 of FIG. 1.

At least one of the TX processor 316, the RX processor 370, and the controller/processor 375 may be configured to perform aspects in connection with the DMRS component 199 and/or the capability component 198 of FIG. 1.

In some aspects, a receiver can combine DMRS symbols across transmission time intervals (TTIs). The combined DMRS may provide a refined channel estimation that can be used to improve demodulation of the received data. For example, a UE can use a refined channel estimation based on a combination of DMRS symbols across TTIs to improve demodulation of a received PDSCH transmission. As another example, a network node, such as a base station may demodulate a received PUSCH transmission based on a combination of DMRSs. As another example, a UE may demodulate a received PSSCH based on a combination of DMRS.

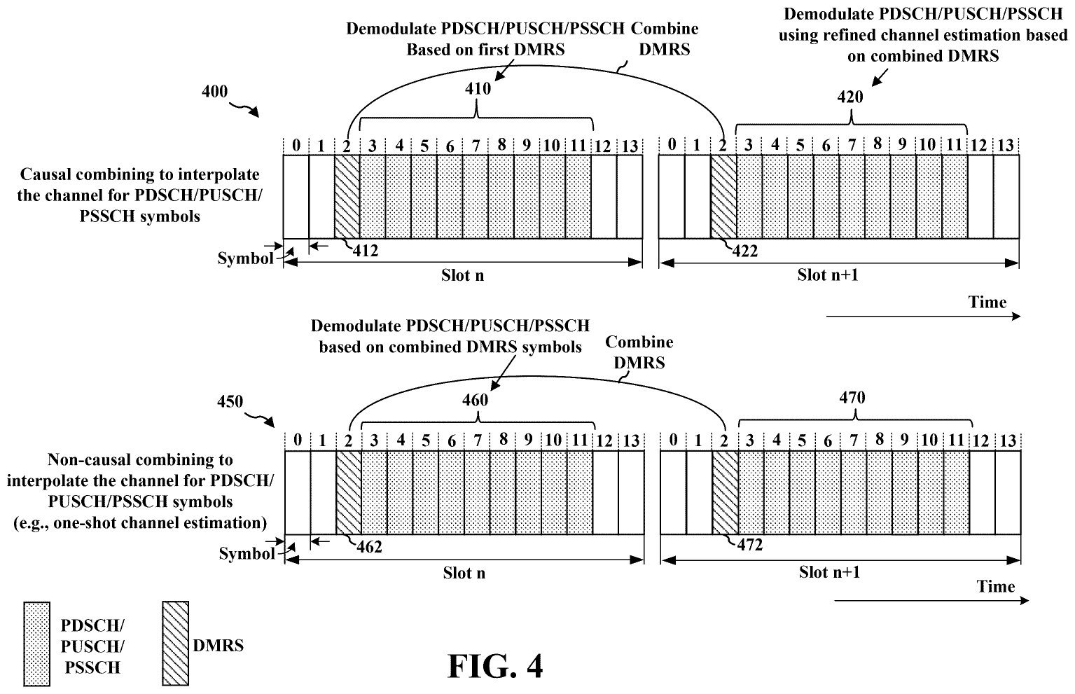

FIG. 4 illustrates an example of causal DMRS combining 400 and non-causal DMRS combining 450 (e.g., one-shot channel estimation). “DMRS combining” refers to channel estimation based DMRSs received in multiple TTIs, e.g., a combination of DMRSs across multiple TTIs. In the examples in FIG. 4, the TTI corresponds to a slot. However, a TTI may correspond to other time durations in other examples. The causal DMRS combining shown at 400 may use the DMRS in later slots (e.g., slot n+1) together with DMRS in a prior slot (e.g., slot n) to obtain a refined channel estimation for use in the later slot(s), e.g., to interpolate the channel for the PDSCH, PUSCH, or PSSCH symbols (e.g., data 420). In causal DMRS combining, the data 410 in slot n is demodulated based on a channel estimation performed using the DMRS 412 received in slot n. In slot n+1, a refined channel estimation is performed using a combination of DMRS 412 from slot n and DMRS 422 from slot n+1. The data 420 in slot n+1 is demodulated using the refined channel estimation based on the combination of DMRS 412 and DMRS 422. This approach can improve the channel estimation for later slots by performing the channel estimation based on preceding slot(s), whereas the first slot is demodulated based on the DMRS received in that slot.

In contrast to the causal DMRS combining shown at 400, the non-causal DMRS combining shown at 450 includes buffering the data 460 (e.g., a data transmission) received in the first TTI (e.g., slot n) until the channel estimation is performed based on the combined DMRS across multiple TTIs (e.g., a channel estimation based on a combination of the DMRS received in slot n and slot n+1). For example, the data 460 (e.g., PDSCH, PUSCH, or PSSCH) received in slot n is buffered until a combined channel estimation is performed based on the DMRS 462 in slot n combined with the DMRS 472 in slot n+1), e.g., to interpolate the channel for the PDSCH, PUSCH, or PSSCH symbols. Then, the data 460 in slot n and the data 470 in slot n+1 are demodulated using the channel estimation on the combined DMRS 462 and DMRS 472. Whereas the data 410 in the causal DMRS combining is demodulated based on the DMRS 412 in slot n, the data 460 in non-causal DMRS combining (or one-shot channel estimation) is buffered and demodulated based on the combination of DMRS 462 in slot n and DMRS 472 in slot n+1. The non-causal combining of DMRS symbols across TTIs can help to avoid lengthy extrapolation in channel estimation based on front loaded DMRS symbols in a slot. The non-causal DMRS combining may also improve channel estimation performance of initial slots in traffic bursts, e.g., which may not be in a position that enables combining with prior TTIs.

The receiver may provide signaling to the transmitter informing the transmitter of its capabilities relating to DMRS combining. In an example in which a UE is the receiver, the UE may provide signaling to the network informing the network about its capability to store DMRS tones and/or channel estimates so that it can combine DMRS with prior TTIs. Although examples are provided with the UE as the receiver and the network as the transmitter, the aspects are similarly applicable to a network node as the receiver and the UE as the transmitter or to a first UE as the receiver and a second UE as the transmitter. Aspects presented herein provide for the receiver (e.g., a UE) to signal different, or additional, capability information beyond a function of the DMRS resources in time, frequency and/or a spatial domain, such as capability information that is a function of the data (e.g., PDSCH, PUSCH, or PSSCH) to be buffered until the DMRS in the next TTI is available. This capability may be associated with, or based on, the UE's memory budget. For example, buffering the data may involve more storage in comparison to storing DMRS tones, as the DMRS tones are sparser in time and/or frequency than the data tones. The UE's capability to store data may place a stricter condition on the placement of DMRS in a later TTI, e.g., in comparison to causal combining (in which the data from the first TTI is not buffered until the later DMRS symbols).

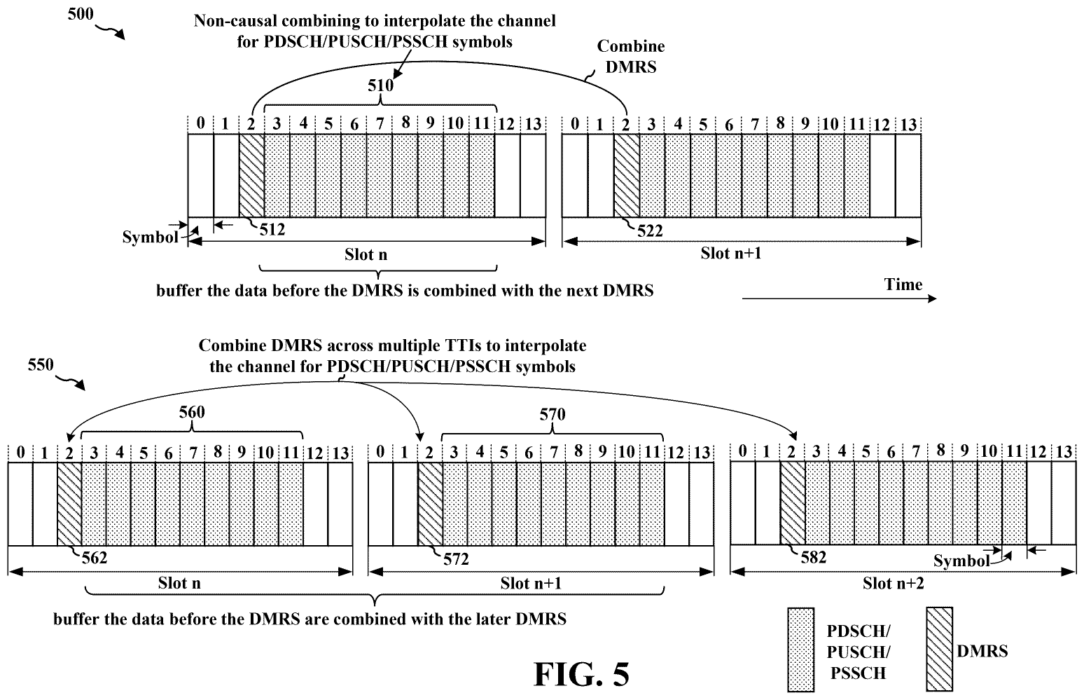

FIG. 5 illustrates an example of non-causal DMRS combining 500 (similar to 450) (e.g., one-shot channel estimation) and shows that the data 510 (e.g., PDSCH transmission, PUSCH transmission, or PSSCH transmission) received in the first TTI (e.g., slot n) is buffered prior to a channel estimation based on the combination of the DMRS 512 in the first TTI and the DMRS 522 in the later TTI (e.g., slot n+1). The receiver may signal a capability to buffer the data for non-causal DMRS combining. Although the example shown at 500 illustrates DMRS combining across two slots (e.g., as an example of two TTIs), the non-causal combining may be across more than two TTIs, e.g., three or more TTIs. FIG. 5 illustrates an example 550 of non-causal DMRS combining (e.g., one-shot channel estimation) across three slots (as an example of non-causal DMRS combining or one-shot channel estimation across more than two TTIs). In the example 550, the data 560 (e.g., PDSCH, PUSCH, or PSSCH) from slot n and the data 570 from slot n+1 are buffered before a channel estimation is performed based on a combination of the DMRS symbols from slot n, slot n+1, and slot n+2 (e.g., DMRS 562, DMRS 572, and DMRS 582).

For example, a UE (as an example of a receiver) can signal the network about the UE's capability to store data (e.g., PDSCH data, PUSCH data, or PSSCH data) for DMRS combining across slots in a non-causal manner (e.g., where the UE buffers the data until the channel estimation based on the combination of DMRS symbols across multiple TTIs).

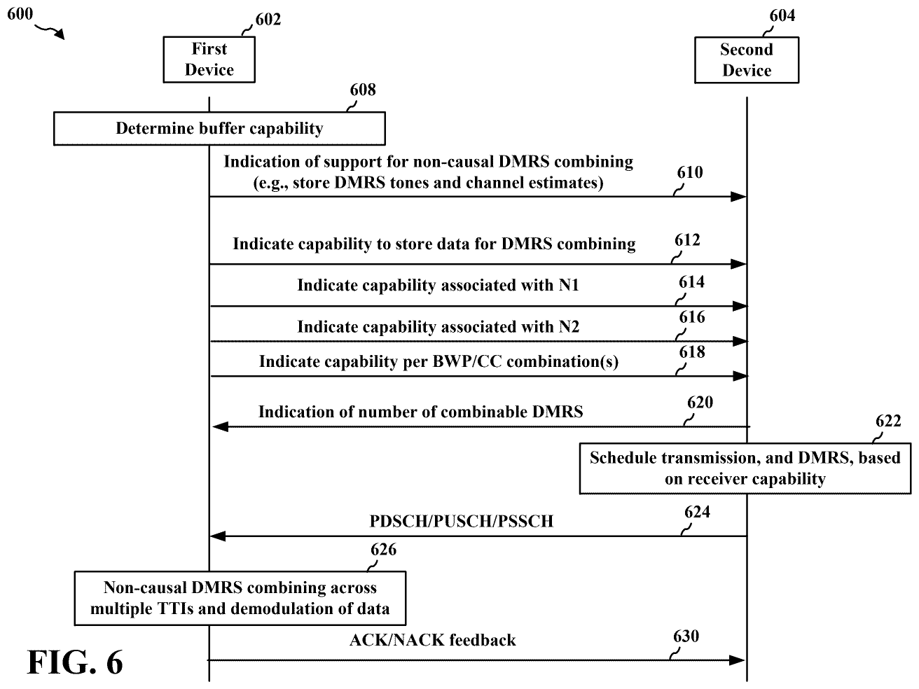

FIG. 6 illustrates an example communication flow 600 between a first wireless device (e.g., first device 602, which may also be referred to as a receiver) and a second wireless device (e.g., second device 604, which may also be referred to as a transmitter). In some aspects, the first device 602 may be a UE, and the second device may be a network node, such as a base station or one or more components of a base station, that transmits PDSCH transmissions to the UE. In some aspects, the first device 602 may be a network node, and the second device 604 may be a UE that transmits PUSCH transmissions to the network node. In some aspects, the first device 602 may be a first UE, and the second device may be a second UE transmitting PSSCH to the first UE.

As illustrated at 612, the first device 602 may transmit, to the second device 604, an indication of support for capability to store data (e.g., PDSCH data, PUSCH data, or PSSCH data) for DMRS combining across slots in a non-causal manner (e.g., where the UE buffers the data until the channel estimation based on the combination of DMRS symbols across multiple TTIs). The capability information, at 612, may be signaled in RRC signaling and/or in a medium access control-control element (MAC-CE). The capability information, at 612, may indicate a maximum amount of data (e.g., PDSCH data, PUSCH data, or PSSCH data) that can be stored by one or more buffers at the first device before flushing the buffer(s).

Factors that determine the storage requested for non-causal combining across slots n and n+1 may include one or more of a time domain, a frequency domain, or a spatial domain for a data transmission. For example, the time domain factor may include, or be based on, a time domain resource allocation of data symbols (e.g., PDSCH symbols, PUSCH symbols, or PSSCH symbols) and a number of DMRS symbols in the TTIs to be combined. For example, a larger amount of time resources allocated for a data transmission may be associated with a larger amount of data storage. As another example, the frequency domain factor may include, or be based on, a frequency domain resource allocation of the data (e.g., PDSCH, PUSCH, or PSSCH), and a DMRS configuration type and port indices in the TTIs to be combined. For example, a larger amount of frequency resources allocated for a data transmission may be associated with a larger amount of data storage. A DMRS configuration that uses less resources may be associated with a larger amount of data storage, e.g., as more resources may be available for a data transmission. The first device 602 may choose to buffer the data/DMRS based on the second device's indication of whether or not non-causal combining is possible and based on the second device not changing the FDRA, a precoder, and TCI states, among other aspects, across the slots. Thus, the storage involved at the first device 602 for the non-causal DMRS combining may be based on the FDRA of a first TTI (e.g., slot n). For example, the spatial domain factor that may affect data storage may include, or be based on, a number of data transmission layers for a data transmission, a number of receiver antennas at the first device to receive a data transmission, and/or a number of transmission configuration information (TCI) groups (e.g., in multiple transmission reception point (mTRP) scenarios) that may be used for a data transmission. For example, a larger number of transmission layers for a data transmission may be associated with a larger amount of data storage. For example, a larger number of receive antennas to receive a data transmission may be associated with a larger amount of data storage. For example, a larger amount of TCI groups for a data transmission may be associated with a larger amount of data storage. Each of these factors may affect the amount of data that may be received by a device, and correspondingly, the amount of data to be stored at the device while the device waits to perform channel estimation on a combination of DMRS across multiple TTIs.

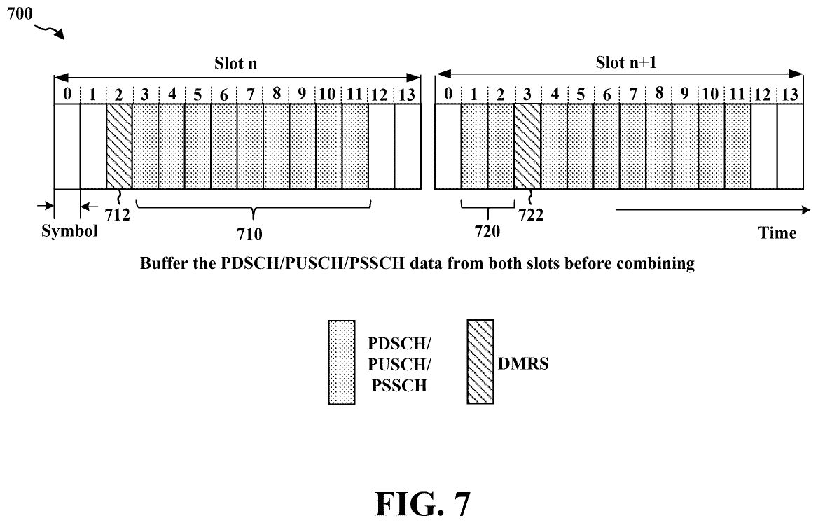

FIG. 7 illustrates an example 700 in which a first TTI (e.g., slot n) includes a front loaded DMRS that occurs prior to the data 710, and a later TTI (e.g., slot n+1) does not include a front loaded DMRS. FIG. 7 shows the DMRS 722 in a fourth symbol of slot n+1 and occurring after data 720, as an example. The example may correspond to PDSCH mapping type A with dmrs-typeA-pos as symbol 3 with the PDSCH starting at symbol 1. In such examples, the UE (as an example of a receiver) buffers the data 710 from the first TTI (e.g., slot n) and the data 720 from the later TTI (e.g., slot n+1) that is before the DMRS 722 in the later TTI (e.g., the data 720 in the second and third symbol of slot n+1). The receiver performs a channel estimation on both DMRS 712 and DMRS 722 to demodulate the data 710 and the data 720. In this example, the amount of buffered data (e.g., at 710 and 720) depends on the TDRA of both TTIs, e.g., both slot n and slot n+1.

In some aspects, the first device 602 may signal the capability, at 612, by signaling the capability relating to one or more of the factors. In some aspects, the second device 604 may consider the one or more factors when scheduling a transmission to the first device.

In some aspects, the first device 602 can indicate its capability, at 612, to the second device 604 in terms of the maximum number of resources per receiver (per Rx) at the first device that can be stored before flushing one or more buffer(s). For example, the first device 602 may indicate the maximum number of time, frequency, and/or spatial domain resources that can be stored before one or more buffers are flushed. The indication may indicate the maximum per receiver and per transmission layer at the first device 602.

In some aspects, the first device 602 can provide the information, at 612, in terms of a maximum number of time and/or frequency resource elements that the first device can buffer. For example, if an integer number (B) is the maximum number of resource elements that the first device can buffer (e.g., max #REs=B), then the UE capability for rank K may correspond to floor (B/K) in units of resource elements.

In some aspects, the first device can provide the information, at 612, in terms of a number of PxSCH and DMRS symbols and a total number of allocated RBs, wherein PxSCH refers to PDSCH, PUSCH, or PSSCH. For example, the information may be provided in terms of a frequency domain resource allocation of the data to be buffered. This example may be similar to the maximum number of time/frequency resources, yet may provide added flexibility for the first device 602 to indicate a split of the storage dedicated to data in comparison to the storage dedicated to DMRS. For example, memory at the first device 602 that is dedicated for storing received tones for a channel may differ from that for storing received tones for data, e.g., due to different resolution and latency requirements for the channel tones in comparison to the data tones. For example, the data tones may have a higher bit resolution requirement and/or a higher tolerance to buffer input/output (I/O) delay than DMRS, because DMRS is to be processed faster to avoid demodulation delays and to meet an N1 timeline. Depending on implementations, the first device 602 (e.g. which may be a UE) may or may not have a distinct buffer architecture and/or distinct properties for data storage in comparison to DMRS storage.

In some aspects, the first device 602 may indicate the capability information, at 612, in terms of a maximum number of bits that the first device 602 can buffer. In some aspects, the maximum number of bits may depend on a specific fixed point storage implementation in the first device, and the first device may prefer to indicate the storage capability in another manner rather than share the fixed point storage implementations with the second device.

In some aspects, the first device's capability to combine DMRSs across multiple TTIs (e.g., slot n and slot n+1) may further depend on the value of a PDSCH-to-HARQ feedback timing indicator or K1 value configured in the first TTI (e.g., slot n). A K1 value may refer to an amount of time for generating ACK/NACK feedback for a received data transmission. For example, for PDSCH, K1 may indicate an amount of time between the PDSCH and a resource for sending the ACK/NACK feedback, e.g., between a slot for PDSCH and slot for PUCCH with feedback.

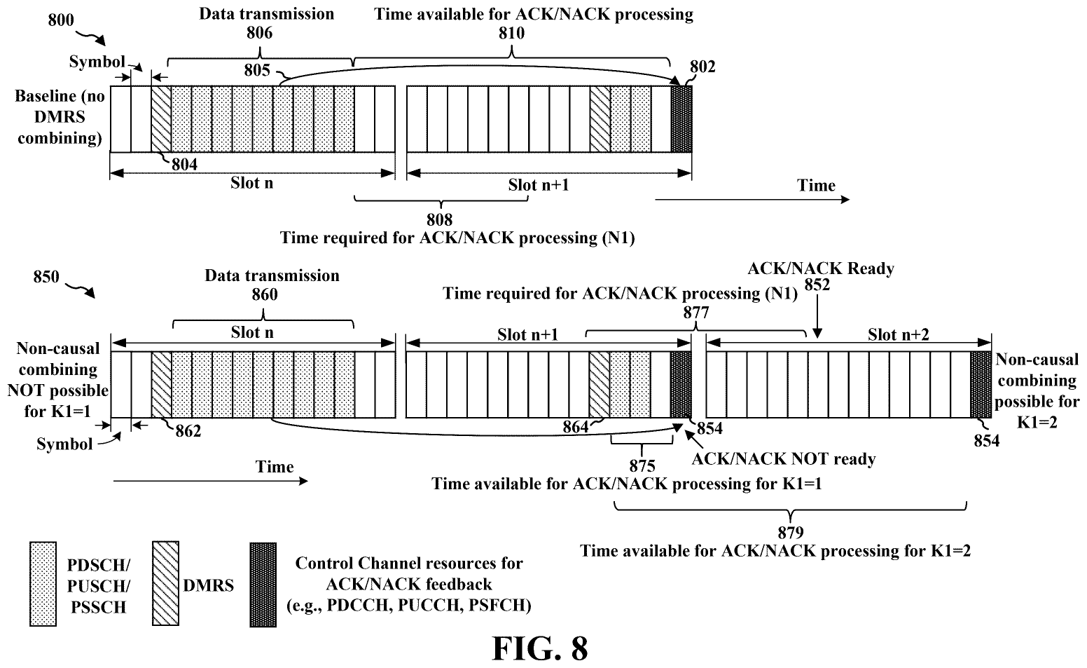

In the extreme case, e.g., for DCI 1_1 format, if K1 is configured to be 0 (for a self-contained slot), then a base station does not expect the UE to combine DMRSs across slots. In general, for a given K1, the UE may be able to combine DMRSs across slots in a non-causal manner if the last DMRS symbol to be combined is more than N symbols prior to the resources allocated for the PUCCH ACK/NACK, where N is a function of the UE capability. Otherwise, the UE may not combine the DMRSs across the slots. FIG. 8 illustrates an example 800 without DMRS combining. The data 806 is demodulated based on a channel estimation of the DMRS 804 received in the same TTI (e.g., slot n) rather than a combination of DMRSs across TTIs. The arrow 805 shows that ACK/NACK feedback for the data 806 is provided in a feedback resource 802. The example 800 shows the time 810 available for ACK/NACK processing between the end of the data transmission (e.g., PDSCH/PUSCH/PSSCH) in slot n and the feedback resource 802 in slot n+1. The example also illustrates the time 808 that the receiver may require for ACK/NACK processing in order to be ready to send the ACK/NACK feedback for the data 806. As the time 808 to process the ACK/NACK feedback is less than the amount of time 810 that is available for the ACK/NACK processing, the receiver is able to send the ACK/NACK feedback in the feedback resources 802. For example, if the receiving device is a UE receiving PDSCH, the ACK/NACK feedback resources may be PUCCH resources. If the receiving device is a UE receiving PSSCH, the ACK/NACK feedback resources may be sidelink feedback resources. If the receiving device is a network node, such as a base station, receiving PUSCH, the ACK/NACK resources may be PDCCH resources.

FIG. 8 also shows an example 850 in which non-causal DMRS combining (e.g., demodulation of data based on channel estimation using DMRS from multiple TTIs) is not possible for the data 860 in slot n for K1=1, because the time 875 available for the ACK/NACK processing for the data 860 (e.g., with a channel estimation based on a combination of the DMRS 864 and the DMRS 862) is less than the time 877 required for ACK/NACK processing. The example 850 shows that the ACK/NACK feedback is ready at point 852 after the control channel resources (e.g., feedback resource 854) for the ACK/NACK feedback. However, as shown in the example, the non-causal DMRS combining to demodulate the data 860 is possible for K1=2, because the feedback resource 854 occur after the ACK/NACK feedback would be ready at 852. The time 879 available for ACK/NACK processing if K1=2 is more than the time 877 required for the ACK/NACK processing

In some aspects, the first device 602 can report, to the second device 604, the minimum number of symbols (e.g., N1), or minimum amount of time, supported between the most recent DMRS symbol to be combined and an earliest of the ACK/NACK symbols for any of the combined slots. FIG. 6 illustrates an example of the first device 602 signaling the information to the second device 604, at 614.

Furthermore, if the reception and subsequent processing of the DMRS symbols in slot n+1 is bottlenecked by a control information (e.g., DCI) decoding delay, then the first device 602 can start ACK/NACK processing for slot n PDSCH at the end of the DCI processing for slot n+1 or the reception of most recent combinable DMRS, whichever is later. Although the example is described for DCI, the concept is similarly applicable for uplink control information (UCI) or sidelink control information (SCI).

Additionally, or alternatively to, N1, the first device may report the minimum number of symbols (e.g., N2) required between the DCI in the last combinable slot and an earliest of the A/N symbols for any of the combinable slots. FIG. 6 illustrates an example of the first device 602 transmitting an indication of support for a capability associated with N2, at 616.

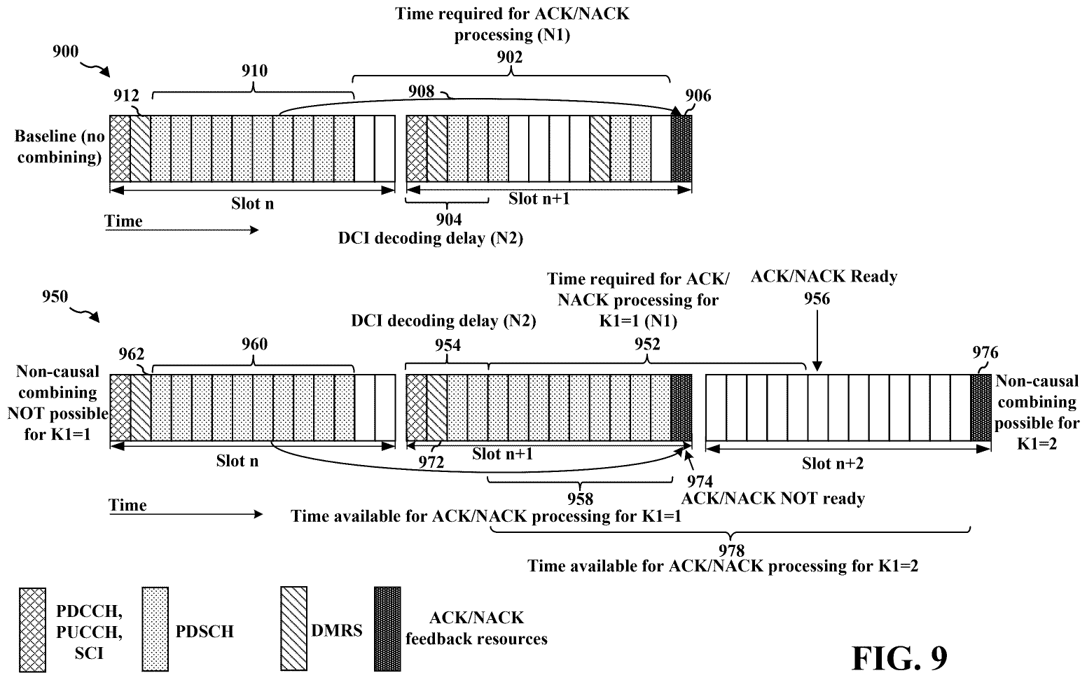

FIG. 9 illustrates an example timeline 900 without DMRS combining and showing the time for ACK/NACK processing 902 (e.g., N1) and the control information (e.g., DCI) decoding delay 904 (e.g., N2). Without DMRS combining, the data 910 received in slot n is demodulated based on a channel estimation that is based on the DMRS 912 received in slot n. The arrow 908 shows that feedback resource 906 is provided for ACK/NACK feedback for the data 910. The example timeline 950 shows that non-causal DMRS combining can be performed to provide feedback based on K1=2 but not for K1=1. The example timeline 950 shows an example of control channel (e.g., DCI) decoding delay 954 (e.g., N2), and the time 952 required for ACK/NACK processing for the data 960 in slot n (with a channel estimation based on the DMRS 962 in slot n and the DMRS 972 in slot n+1) following a DCI decoding delay 954. Although the example is described for DCI (e.g., for PDSCH transmission), the concept is similarly applicable for UCI (e.g. for PUSCH transmission) or SCI (e.g., for sidelink transmission). The example timeline 950 illustrates that the time 952 required for ACK/NACK processing (e.g., N1) is longer than the time available for ACK/NACK processing if K1=1, as shown at 958. For example, the ACK/NACK is ready at time 956, after the feedback resources 974 in slot n+1. N1 in the examples presented herein is different than an N1 time line margin in NR, for example. In the example timeline 950, non-causal DMRS combining would not be possible for K1=1, but would be possible for K1=2. For example, if K1=2, the feedback resource 976 is after the ACK/NACK is ready at 956, and the time 978 available for the ACK/NACK processing if K1=2 is more than the time 952 required for the ACK/NACK processing.

Based on the report from the first device 602 and a configured K1, if the second device 604 expects the first device 602 to combine DMRSs non-causally, then the second device 604 may choose to avoid transmitting control information scheduling the combinable DMRS and/or a last DMRS symbol within a number of symbols based on the N1 and N2 indicated by the first device (e.g., within max (N1, N2) symbols from the ACK/NACK symbols for the data transmission).

In some aspects, the first device 602 may report a higher capability for DMRS combining in a multi-carrier scenario in comparison to a single carrier scenario. As an example to illustrate the concept, if a UE is configured with a primary component carrier (PCC) and two secondary component carriers (e.g., SCCs), and the base station deactivates one of the SCCs, the UE can use the increased buffer capacity toward non-causal DMRS combining over a higher number of slots or DMRS symbols for the PCC and the remaining SCC. As another example, if the UE switches from a wider bandwidth part (BWP) to a narrower BWP, the UE may use the increased buffer capacity toward non-causal DMRS combining over a higher number of slots or DMRS symbols for the narrower BWP.

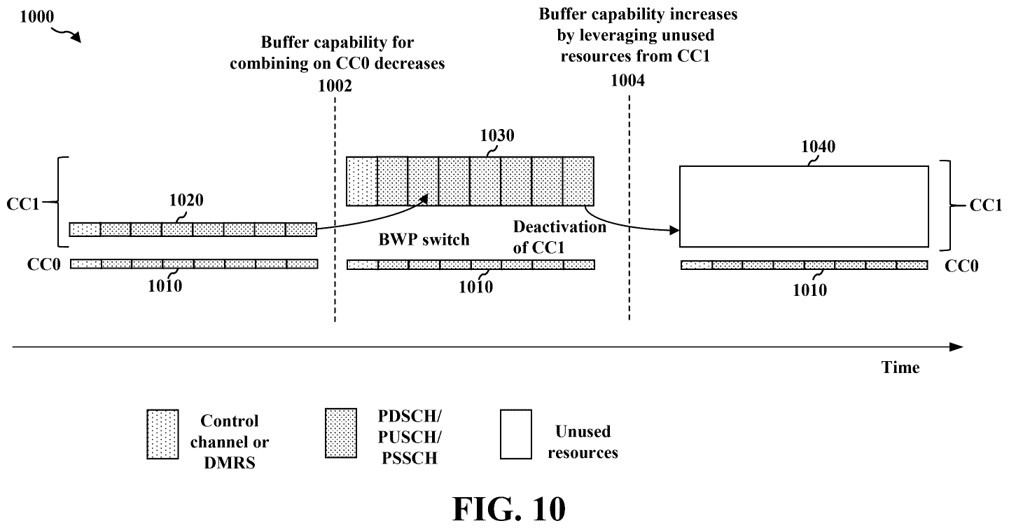

FIG. 10 illustrates an example 1000 of a change in buffer capability (or capacity) based on changes in carriers or BWPs. At a first point in time, the first device 602 may communicate using a first BWP 1010 on a first carrier (e.g., CC0) and a second BWP 1020 on a second carrier (e.g., CC1). The first device 602 may perform a BWP switch from the second BWP 1020 on CC1 to a third BWP 1030 on CC1. When the switch occurs (e.g., as shown at 1002), the buffer capacity, or capability for DMRS combining on CC0 decreases based on the third BWP having a wider bandwidth than the second BWP. If the second carrier, e.g., CC1 is deactivated, the buffer capability of the first device 602 increases (as shown at 1004) by allowing the first device 602 to leverage the unused buffer resources (e.g., illustrated at 1040) that were previously used for CC1.

In some aspects, the first device may can signal its buffer capability for non-causal DMRS combining for each of the BWP/CC combinations supported under its CA capability. For example, the first device may indicate a buffer capability for non-causal DMRS combining for each BWP combination supported under a CA capability. As another example, the first device 602 may indicate a buffer capability for non-causal DMRS combining for each CC combination for CA that is supported by the first device 602. For example, as part of the determination at 608, the first device may determine, and then report at 618, the buffer capability for non-causal DMRS combining for each possible combination supported by the first device.

In some aspects, the first device 602 may take into account the difference in numerology (e.g., if any) across carriers/BWPs before computing the buffer capability of the first device.

Based on a higher buffer capability of the first device 602, the second device 604 may allow non-causal combining of more than 1 DMRS symbols from a later TTI, or even combining multiple DMRS symbols from multiple later TTIs. As an example, an advanced UE or a premiere tier UE may have an increased buffer capability in comparison to other UEs.

In some aspects, the second device 604 may indicate, at 620, the total number of DMRS symbols that are combinable in a non-causal way over two or more TTIs. The indicated total number may be based on the UE capability report (e.g., including any of 610, 612, 614, and/or 618). This indication 620 may be indicated through DCI in slot n for combining DMRS symbols from slot n+1 and later, as an example.

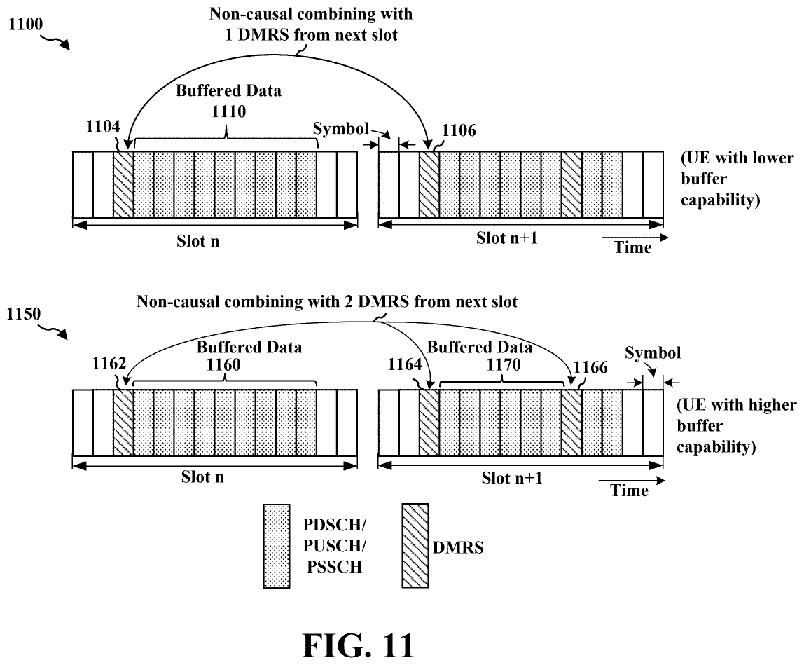

FIG. 11 illustrates an example 1100 of non-causal DMRS combining in which a DMRS 1104 from slot n is combined with a DMRS 1106 from slot n+1 for a channel estimation for a total of 2 DMRS symbols (e.g. which may be performed by a first device 602 having a lower buffer capability) to demodulate the data 1110. In the example 1150, channel estimation is performed on a combination of the DMRS 1162 from slot n with two DMRS from slot n+1 (e.g., DMRS 1164 and DMRS 1166 for a total of 3 DMRS). The data 1160 from slot n and the data 1170 in slot n+1 prior to the DMRS 1166 is buffered in order to demodulate the data based on the channel estimation on the combined DMRS (e.g., the combination of DMRS 1162, DMRS 1164, and DMRS 1166). The example 1150 may be performed by a first device 602 having a higher buffer capability, for example.

A final decision about whether to combine DMRSs may be made by the first device, e.g., depending on other channel conditions, such as doppler and K1 values of combinable data transmissions (e.g., combinable PDSCH transmissions, combinable PUSCH transmissions, or combinable PSSCH transmissions as one example).

In some aspects, the first device may indicate support for non-causal DMRS combining, at 610, e.g., including a capability for storing DMRS tones and channel estimates.

In some aspects, the information of one or more of 610, 612, 614, and/or 618 may be signaled in a single transmission or single message. In some aspects, the information of one or more of 610, 612, 614, and/or 618 may be signaled in separate messages or separate transmissions.

FIG. 6 also illustrates, at 608, that the first device 602 may determine its buffer capacity associated with non-causal DMRS combining, e.g., for buffering data while waiting to combine DMRSs in later TTIs, before reporting one or more of the capabilities at 610, 612, 614, 616, and/or 618.

As illustrated at 622, the second device may schedule transmissions (e.g., data transmission) to the first device and DMRS based on the capability reported by the first device 602. The second device may then transmit the transmissions (e.g., PDSCH, PUSCH, or PSSCH) at 624. At 626, the first device may perform the non-causal DMRS combining across multiple TTIs and demodulation of the data received at 624. At 630, the first device 602 may transmit ACK/NACK feedback.

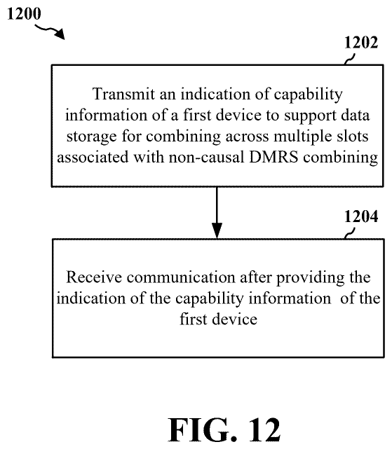

FIG. 12 is a flowchart 1200 of a method of wireless communication at a first device. In some aspects, the first device may be the first device 602 in FIG. 6. In some aspects, the method may be performed by a UE (e.g., the UE 104, 350; the apparatus 1404). In some aspects, the method may be performed by a network node such as a base station or one or more components of a base station (e.g., the base station 102, 310; the network entity 1502). The method may improve data reception through non-causal DMRS combining by providing a second device with data buffering capability of the first device.

At 1202, the first device transmits an indication of capability information of a first device to support data storage associated with non-causal DMRS combining across multiple slots. The indication may include any of the aspects described in connection with 612, 614, 616, and/or 620 in FIG. 6, for example. The non-causal DMRS combining may include any of the combining aspects described in connection with FIGS. 4-11. The transmission may be performed, e.g., by the capability component 198 of the apparatus 1404 and/or the network entity 1502. In some aspects, the indication may include capability information that is included in one or more of RRC signaling or a MAC-CE message. In some aspects, the indication indicates a maximum amount of the data storage that the first device supports for the non-causal DMRS combining. In some aspects, an amount of the data storage may be based on one or more of: a time domain resource allocation for data symbols and a number of DMRS symbols in the multiple slots, a frequency domain resource allocation for data transmission, a DMRS configuration type and port indices in the multiple slots, a number of data transmission layers, a number of receive antennas, or a number of TCI groups (e.g., for a scenario with multiple transmission and reception points (TRPs)). In some aspects, the capability information indicates a maximum amount of the data storage that the first device supports as a maximum number of resources that the first device can store per receive antenna and/or per transmission layer before a data storage buffer is flushed (e.g., before the first device needs to flush the data storage buffer). The resources may be based on one or more of a time domain, a frequency domain, or a spatial domain, for example. In some aspects, the maximum amount of the data storage is indicated as a maximum number of time and frequency resource elements that the first device supports for storage before the first device needs to flush the buffer. In some aspects, the capability information indicates a maximum amount of the data storage is based on a first number of data symbols, a second number of DMRS symbols, and a total number of allocated resource blocks.

At 1204, the first device receives a communication after providing the indication of the maximum amount of the data storage that the first device supports. FIG. 6 illustrates an example of communication received at 624 after the first device signals its support for one or more capabilities relating to non-causal DMRS combining. The communication may include any of the aspects described in connection with FIGS. 4-11, for example. The reception may be performed, e.g., by the capability component 198 of the apparatus 1404 and/or the network entity 1502. In some aspects, to receive the communication, the first device may perform a one-shot channel estimation based on a combination of each DMRS transmission across the multiple slots, store data included in at least one slot of the multiple slots of the communication until the one-shot channel estimation is complete; and demodulate the data based on the one-shot channel estimation. FIG. 6 illustrates an example at 626, of non-causal DMRS combining that includes buffering data until a one-shot channel estimation is performed for DMRS across multiple TTIs, after which the data is demodulated.

In some aspects, the first device may further transmit an additional indication of a minimum number of symbols between a DMRS symbol to be combined and an earliest feedback symbol across one or more of the multiple slots combined. For example, FIG. 6 illustrates an example of the first device transmitting an indication of N1 at 614. The transmission may be performed, e.g., by the capability component 198 of the apparatus 1404 and/or the network entity 1502.

In some aspects, the first device may further transmit an additional indication of a minimum number of symbols between a control information in a last combinable slot and an earliest feedback symbol across one or more of the multiple slots combined. For example, FIG. 6 illustrates an example of the first device transmitting an indication of N2 at 616. The transmission may be performed, e.g., by the capability component 198 of the apparatus 1404 and/or the network entity 1502.

In some aspects, the first device may further transmit an additional indication of a buffer capability for non-causal DMRS combining within a carrier aggregation capability, where the buffer capability is for combinations including one or more of bandwidth parts (BWPs) or component carriers (CCs). In some aspects, the first device may further transmit an additional indication of a buffer capability for non-causal DMRS combining for each component carrier combination within a carrier aggregation capability. For example, FIG. 6 illustrates an example of the first device transmitting an indication for each BWP/CC combination at 618. The transmission may be performed, e.g., by the capability component 198 of the apparatus 1404 and/or the network entity 1502.

In some aspects, the first device may receive information indicating a total number of DMRS symbols that are combinable for one-shot channel estimation (e.g., DMRS combining in a non-causal manner) over two or more TTIs. A “DMRS symbol” refers to a symbol that includes a DMRS. When the first device combines “DMRS symbols,” the device performs channel estimation on a combination of DMRSs received in the symbols. FIG. 6 illustrates an example of the first device 602 receiving the indication at 620. The information may be comprised in control information in a slot for combining DMRS symbols across one or more of the subsequent slots. In some aspects, the total number of the DMRS symbols that the first device combines may be based on the information (e.g., indicating the combinable amount) and/or one or more channel conditions. The reception may be performed, e.g., by the capability component 198 of the apparatus 1404 and/or the network entity 1502.

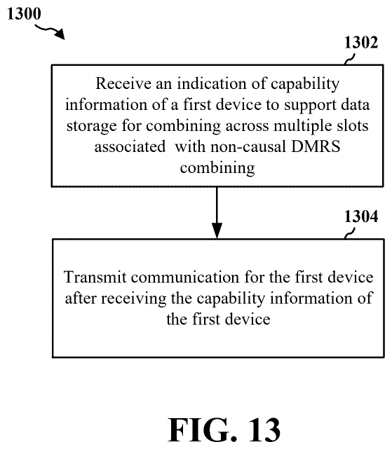

FIG. 13 is a flowchart 1300 of a method of wireless communication at a second device. In some aspects, the second device may be the second device 604 in FIG. 6. In some aspects, the method may be performed by a UE (e.g., the UE 104, 350; the apparatus 1404). In some aspects, the method may be performed by a network node such as a base station or one or more components of a base station (e.g., the base station 102, 310; the network entity 1502). The method may improve data reception through non-causal DMRS combining by receiving with data buffering capability of the first device.

At 1302, the second device obtains an indication of a capability information of a first device to support data storage associated with non-causal DMRS combining across multiple slots. In some aspects, the capability information indicates a maximum amount of the data storage that the first device supports as a maximum number of resources that the first device can store per receive antenna and per transmission layer before a data storage buffer is flushed, wherein the resources are based on one or more of a time domain, a frequency domain or a spatial domain. The indication may include any of the aspects described in connection with 612, 614, 616, and/or 620 in FIG. 6, for example. The non-causal DMRS combining (e.g., which may be referred to as one-shot channel estimation) may include any of the combining aspects described in connection with FIGS. 4-11. The obtaining (e.g., reception) may be performed, e.g., by the DMRS component 199 of the apparatus 1404 and/or the network entity 1502.

At 1304, the second device provides a communication for the first device after receiving the capability information. FIG. 6 illustrates an example of communication, at 624, after the first device signals its support for one or more capabilities relating to non-causal DMRS combining. The communication may include any of the aspects described in connection with FIGS. 4-11, for example. The providing (e.g., transmission) may be performed, e.g., by the DMRS component 199 of the apparatus 1404 and/or the network entity 1502.

In some aspects, the second device may further obtain an additional indication of a minimum number of symbols between a DMRS symbol to be combined and an earliest feedback symbol across one or more of the multiple slots. For example, FIG. 6 illustrates an example of the second device receiving an indication of N1 at 614. The obtaining (e.g., reception) may be performed, e.g., by the DMRS component 199 of the apparatus 1404 and/or the network entity 1502.

In some aspects, the second device may further obtain an additional indication of a minimum number of symbols between a control information in a last combinable slot and an earliest feedback symbol across one or more of the multiple slots. For example, FIG. 6 illustrates an example of the second device receiving an indication of N2 at 616. The obtaining (e.g., reception) may be performed, e.g., by the DMRS component 199 of the apparatus 1404 and/or the network entity 1502.

In some aspects, the second device may further obtain first indication of a first buffer capability for non-causal DMRS combining within a carrier aggregation capability, wherein the buffer capability is for combinations including one or more of BWPs or CCs. For example, FIG. 6 illustrates an example of the second device receiving an indication for each BWP/CC combination at 618. The obtaining (e.g., reception) may be performed, e.g., by the DMRS component 199 of the apparatus 1404 and/or the network entity 1502.

In some aspects, the second device may further provide information for the first device indicating a total number of DMRS symbols that are combinable in a non-causal manner over two or more TTIs. FIG. 6 illustrates an example of the second device 604 providing the indication at 620. The providing (e.g., transmission) may be performed, e.g., by the DMRS component 199 of the apparatus 1404 and/or the network entity 1502.

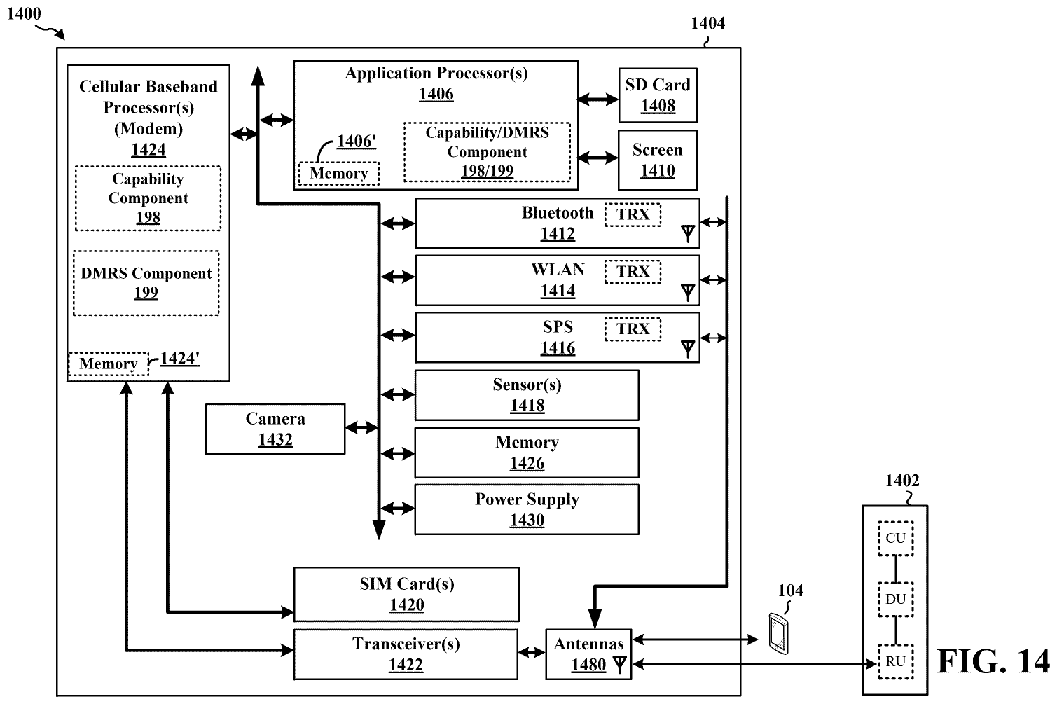

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) 1424 communicates through the transceiver(s) 1422 via one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The cellular baseband processor(s) 1424 and the application processor(s) 1406 are configured to perform the various functions described supra based at least in part of the information stored in the memory. That is, the cellular baseband processor(s) 1424 and the application processor(s) 1406 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see UE 350 of FIG. 3) and include the additional modules of the apparatus 1404.

As discussed supra, the component 198 may be configured to transmit an indication of capability information of the first device to support data storage associated with non-causal DMRS combining across multiple slots; and receive a communication after providing the indication of the capability information. In some aspects, the component 198 and/or the apparatus 1404 may be further configured to transmit an additional indication of a minimum number of symbols between a DMRS symbol to be combined and an earliest feedback symbol across one or more of the multiple slots. In some aspects, the component 198 and/or the apparatus 1404 may be further configured to transmit an additional indication of a minimum number of symbols between a control information in a last combinable slot and an earliest feedback symbol across one or more of the multiple slots. In some aspects, the component 198 and/or the apparatus 1404 may be further configured to transmit an additional indication of a buffer capability for non-causal DMRS combining for each BWP combination within a carrier aggregation capability. In some aspects, the component 198 and/or the apparatus 1404 may be further configured to transmit an additional indication of a buffer capability for non-causal DMRS combining within a carrier aggregation capability, wherein the buffer capability is for combinations including one or more of BWPs or CCs. In some aspects, the component 198 and/or the apparatus 1404 may be further configured to receive information indicating a total number of DMRS symbols that are combinable for one-shot channel estimation (e.g., in a non-causal manner) over two or more TTIs. In some aspects, the component 198 and/or the apparatus 1404 may be further configured to determine the total number of the DMRS symbols that are combinable based on the information and one or more channel conditions. In some aspects, the apparatus 1404 may include a component 199 that is configured to receive (or obtain) receiving an indication of capability information of a first device to support data storage associated with non-causal DMRS combining across multiple slots; and transmit (or provide) a communication for the first device after receiving the indication of the capability information. In some aspects, the apparatus 1404 may further be configured to obtain an additional indication of a minimum number of symbols between a DMRS symbol to be combined and an earliest feedback symbol across one or more of the multiple slots. In some aspects, the apparatus 1404 may further be configured to obtain an additional indication of a minimum number of symbols between a control information in a last combinable slot and an earliest feedback symbol across one or more of the multiple slots. In some aspects, the apparatus 1404 may further be configured to obtain a first indication of a buffer capability for non-causal DMRS combining within a carrier aggregation capability, wherein the buffer capability is for combinations including one or more of BWPs or CCs. In some aspects, the apparatus 1404 may further be configured to provide information for the first device indicating a total number of DMRS symbols that are combinable for one-shot channel estimation (e.g., in a non-causal manner) over two or more TTIs. The component 198 may be within the cellular baseband processor(s) 1424, the application processor(s) 1406, or both the cellular baseband processor(s) 1424 and the application processor(s) 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for an indication of capability information of the first device to support data storage associated with non-causal DMRS combining across multiple slots; and means for receiving a communication after providing the indication of the capability information. In some aspects, the apparatus 1404 may further include means for transmitting an additional indication of a minimum number of symbols between a DMRS symbol to be combined and an earliest feedback symbol across one or more of the multiple slots. In some aspects, the apparatus 1404 may further include means for transmitting an additional indication of a minimum number of symbols between a control information in a last combinable slot and an earliest feedback symbol across one or more of the multiple slots. In some aspects, the apparatus 1404 may further include means for transmitting an additional indication of a buffer capability for non-causal DMRS combining within a carrier aggregation capability, wherein the buffer capability is for combinations including one or more of BWPs or CCs. In some aspects, the apparatus 1404 may further include means for receiving information indicating a total number of DMRS symbols that are combinable for on-shot channel estimation over two or more TTIs. In some aspects, the apparatus 1404 may further include means for determining the total number of the DMRS symbols that are combinable based on the information and one or more channel conditions. In some aspects, the apparatus 1404 may include means for an indication of capability information of a first device to support data storage associated with non-causal DMRS combining across multiple slots; and means for transmitting communication for the first device after receiving the capability information of the first device. In some aspects, the apparatus 1404 may further include means for receiving an additional indication of a minimum number of symbols between a DMRS symbol to be combined and an earliest feedback symbol across one or more of the multiple slots. In some aspects, the apparatus 1404 may further include means for receiving an additional indication of a minimum number of symbols between a control information in a last combinable slot and an earliest feedback symbol across one or more of the multiple slots. In some aspects, the apparatus 1404 may further include means for receiving an additional indication of a buffer capability for non-causal DMRS combining within a carrier aggregation capability, wherein the buffer capability is for combinations including one or more of BWPs or CCs. In some aspects, the apparatus 1404 may further include means for transmitting information for the first device indicating a total number of DMRS symbols that are combinable for one-shot channel estimation over two or more TTIs. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

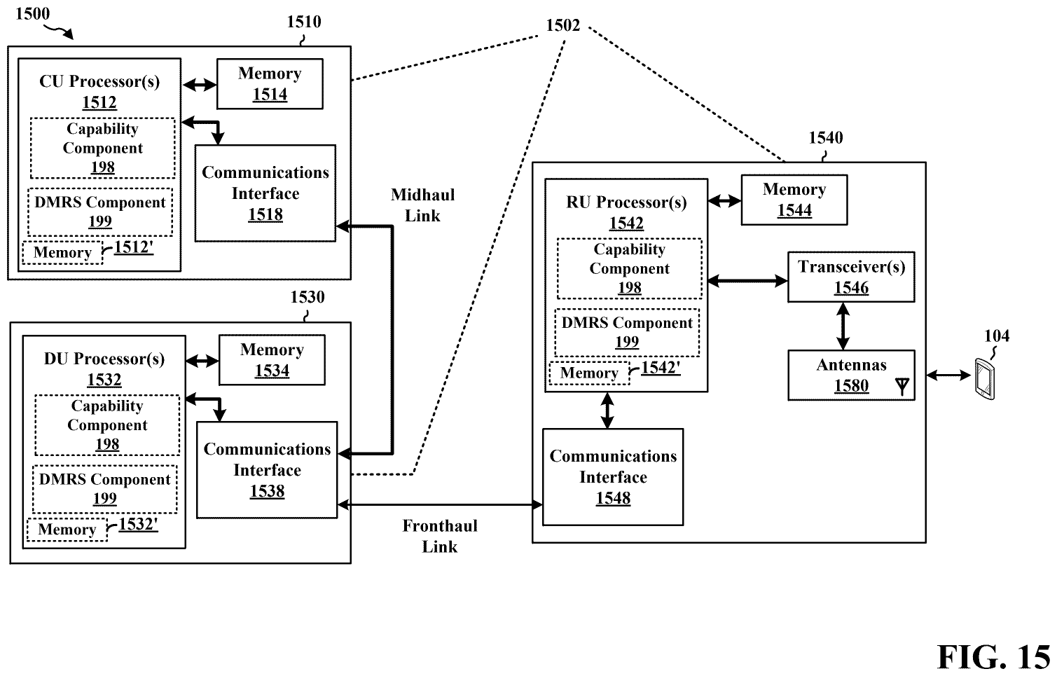

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor 1512. The CU processor(s) 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor 1532. The DU processor(s) 1532 may include on-chip memory 1532′. In some aspects, the DU 1530 may further include additional memory modules 1534 and a communications interface 1538. The DU 1530 communicates with the RU 1540 through a fronthaul link. The RU 1540 may include at least one RU processor 1542. The RU processor(s) 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit an indication of capability information of the first device to support data storage associated with non-causal DMRS combining across multiple slots; and receive communication after providing the indication of the capability information. In some aspects, the component 198 and/or the network entity 1502 may be further configured to transmit an additional indication of a minimum number of symbols between a DMRS symbol to be combined and an earliest feedback symbol across one or more of the multiple slots. In some aspects, the component 198 and/or the network entity 1502 may be further configured to transmit an additional indication of a minimum number of symbols between a control information in a last combinable slot and an earliest feedback symbol across one or more of the multiple slots. In some aspects, the component 198 and/or the network entity 1502 may be further configured to transmit an additional indication of a buffer capability for non-causal DMRS combining for each BWP combination within a carrier aggregation capability. In some aspects, the component 198 and/or the network entity 1502 may be further configured to transmit an additional indication of a buffer capability for non-causal DMRS combining within a carrier aggregation capability, wherein the buffer capability is for combinations including one or more of BWPs or CCs. In some aspects, the component 198 and/or the network entity 1502 may be further configured to receive information indicating a total number of DMRS symbols that are combinable for one-shot channel estimation over two or more TTIs. In some aspects, the component 198 and/or the network entity 1502 may be further configured to determine the total number of the DMRS symbols that are combinable based on the information and one or more channel conditions. In some aspects, the network entity 1502 may include a component 199 that is configured to receive (or obtain) an indication of capability information of a first device to support data storage associated with non-causal DMRS combining across multiple slots; and transmit (or provide) a communication for the first device after receiving the indication of the capability information. In some aspects, the component 198 and/or the network entity 1502 may further be configured to receive an additional indication of a minimum number of symbols between a DMRS symbol to be combined and an earliest feedback symbol across one or more of the multiple slots. In some aspects, the component 198 and/or the network entity 1502 may further be configured to receive an additional indication of a minimum number of symbols between a control information in a last combinable slot and an earliest feedback symbol across one or more of the multiple slots. In some aspects, the component 198 and/or the network entity 1502 may further be configured to receive a first indication of a buffer capability for non-causal DMRS combining within a carrier aggregation capability, wherein the buffer capability is for combinations including one or more of BWPs or CCs. In some aspects, the component 198 and/or the network entity 1502 may further be configured to transmit information for the first device indicating a total number of DMRS symbols that are combinable in a non-causal manner over two or more TTIs. The component 199 may be within one or more processors of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 may include means for transmitting an indication of capability information of the first device to support data storage associated with non-causal DMRS combining across multiple slots; and means for receiving a communication after providing the indication of the capability information. In some aspects, the network entity 1502 may further include means for transmitting an additional indication of a minimum number of symbols between a DMRS symbol to be combined and an earliest feedback symbol across one or more of the multiple slots. In some aspects, the network entity 1502 may further include means for transmitting an additional indication of a minimum number of symbols between a control information in a last combinable slot and an earliest feedback symbol across one or more of the multiple slots. In some aspects, the network entity 1502 may further include means for transmitting an additional indication of a buffer capability for non-causal DMRS combining within a carrier aggregation capability, wherein the buffer capability is for combinations including one or more of BWPs or CCs. In some aspects, the network entity 1502 may further include means for receiving information indicating a total number of DMRS symbols that are combinable in a non-causal manner over two or more TTIs. In some aspects, the network entity 1502 may further include means for determining the total number of the DMRS symbols that are combinable based on the information and one or more channel conditions. In some aspects, the network entity 1502 may include means for receiving an indication of capability information of a first device to support data storage associated with non-causal DMRS combining across multiple slots; and means for transmitting a communication for the first device after receiving the capability information. In some aspects, the network entity 1502 may further include means for receiving an additional indication of a minimum number of symbols between a DMRS symbol to be combined and an earliest feedback symbol across one or more of the multiple slots. In some aspects, the network entity 1502 may further include means for receiving an additional indication of a minimum number of symbols between a control information in a last combinable slot and an earliest feedback symbol across one or more of the multiple slots. In some aspects, the network entity 1502 may further include means for receiving an additional indication of a buffer capability for non-causal DMRS combining within a carrier aggregation capability, wherein the buffer capability is for combinations including one or more of BWPs or CCs. In some aspects, the network entity 1502 may further include means for transmitting information for the first device indicating a total number of DMRS symbols that are combinable in a non-causal manner over two or more TTIs. The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first device, comprising: transmitting an indication of capability information of the first device to support data storage associated with non-causal DMRS combining across multiple slots; and receiving a communication after providing the indication of the capability information.

In aspect 2, the method of aspect 1 further includes that the indication of the capability information is included in one or more of RRC signaling or a MAC-CE.

In aspect 3, the method of aspect 1 or aspect 2 further includes that the indication indicates a maximum amount of the data storage that the first device supports for the non-causal DMRS combining.

In aspect 4, the method of any of aspects 1-3 further includes that receiving the communication includes: performing a one-shot channel estimation based on a combination of each DMRS transmission across the multiple slots; storing data included in at least one slot of the multiple slots of the communication until the one-shot channel estimation is complete; and demodulating the data based on the one-shot channel estimation.

In aspect 5, the method of any of aspects 1-4 further includes that an amount of the data storage is based on one or more of: a time domain resource allocation for data symbols and a number of DMRS symbols in the multiple slots, a frequency domain resource allocation for data transmission, a DMRS configuration type and port indices in the multiple slots, a number of data transmission layers, a number of receive antennas, or a number of TCI groups for multiple TRPs.

In aspect 6, the method of any of aspects 1-5 further includes that the capability information indicates a maximum amount of the data storage that the first device supports as a maximum number of resources that the first device can store per receive antenna and per transmission layer before a data storage buffer is flushed, wherein the resources are based on one or more of a time domain, a frequency domain or a spatial domain.

In aspect 7, the method of aspect 6 further includes that the maximum amount of the data storage is indicated as a maximum number of time and frequency resource elements that the first device supports for storage before needing to flush a buffer.

In aspect 8, the method of aspect 6 further includes that the maximum amount of the data storage is based on a first number of data symbols, a second number of DMRS symbols and a total number of allocated resource blocks.

In aspect 9, the method of any of aspects 1-8 further includes transmitting an additional indication of a minimum number of symbols between a DMRS symbol to be combined and an earliest feedback symbol across one or more of the multiple slots.

In aspect 10, the method of any of aspects 1-9 further includes transmitting an additional indication of a minimum number of symbols between a control information in a last combinable slot and an earliest feedback symbol across one or more of the multiple slots.

In aspect 11, the method of any of aspects 1-10 further includes transmitting an additional indication of a buffer capability for non-causal DMRS combining within a carrier aggregation capability, wherein the buffer capability is for combinations including one or more of BWPs or CCs.

In aspect 12, the method of any of aspects 1-11 further includes receiving information indicating a total number of DMRS symbols that are combinable for one-shot channel estimation (e.g., in a non-causal manner) over two or more TTIs.

In aspect 13, the method of any aspect 12 further includes that the information is comprised in control information in a slot for combining DMRS symbols across one or more subsequent slots.

In aspect 14, the method of aspect 12 or aspect 13 further includes determining the total number of DMRS symbols to combine at the first device is based on the information and one or more channel conditions.

Aspect 15 is a method of wireless communication at a second device, comprising: receiving an indication of capability information of a first device to support data storage associated with non-causal DMRS combining across multiple slots; and transmitting a communication for the first device after receiving the capability information.

In aspect 16, the method of aspect 15 further includes that the capability information indicates a maximum amount of the data storage that the first device supports as a maximum number of resources that the first device can store per receive antenna and per transmission layer before flush of a data storage buffer, wherein the resources are based on one or more of a time domain, a frequency domain or a spatial domain.

In aspect 17, the method of aspect 16 further includes that the maximum amount of the data storage is indicated as a maximum number of time and frequency resource elements that the first device supports for storage before a buffer is flushed.

In aspect 18, the method of any of aspects 15-17 further includes receiving an additional indication of a minimum number of symbols between a DMRS symbol to be combined and an earliest feedback symbol across one or more of the multiple slots.

In aspect 19, the method of any of aspects 15-18 further includes receiving an additional indication of a minimum number of symbols between a control information in a last combinable slot and an earliest feedback symbol across one or more of the multiple slots.

In aspect 20, the method of any of aspects 15-19 further includes receiving an additional indication of a buffer capability for non-causal DMRS combining within a carrier aggregation capability, wherein the buffer capability is for combinations including one or more of BWPs or CCs.

In aspect 21, the method of any of aspects 15-20 further includes transmitting information for the first device indicating a total number of DMRS symbols that are combinable for one-shot channel estimation over two or more TTIs.

Aspect 22 is an apparatus for wireless communication at a first device, comprising: at least one memory; and at least one processor coupled to the at least one memory, the at least one processor, individually or in any combination, is configured to perform the method of any of aspects 1 to 14.

Aspect 23 is an apparatus for wireless communication at a first device, comprising: one or more memories; and one or more processors coupled to the one or more memories, the one or more processors, individually or in any combination, are configured to cause the first device to perform the method of any of aspects 1 to 14.

Aspect 24 is an apparatus for wireless communication at a first device, comprising: memory circuitry; and processor circuitry coupled to the memory circuitry, wherein the processor circuitry is configured, based at least in part on information stored in the memory circuitry, to perform the method of any of aspects 1 to 14.

Aspect 25 is an apparatus for wireless communication at a first device, comprising means for performing each step in the method of any of aspects 1 to 14.

Aspect 26 is the apparatus of any of aspects 22 to 25, further comprising a transceiver configured to receive or to transmit in association with the method of any of aspects 1 to 14.

Aspect 27 is a computer-readable medium storing computer executable code at a first device, the code when executed by at least one processor causes the at least one processor to perform the method of any of aspects 1 to 14.

Aspect 28 is an apparatus for wireless communication at a second device, comprising: at least one memory; and at least one processor coupled to the at least one memory, the at least one processor, individually or in any combination, is configured to perform the method of any of aspects 15 to 21.

Aspect 29 is an apparatus for wireless communication at a second device, comprising: one or more memories; and one or more processors coupled to the one or more memories, the one or more processors, individually or in any combination, are configured to cause the second device to perform the method of any of aspects 15 to 21.

Aspect 30 is an apparatus for wireless communication at a second device, comprising: memory circuitry; and processor circuitry coupled to the memory circuitry, wherein the processor circuitry is configured, based at least in part on information stored in the memory circuitry, to perform the method of any of aspects 15 to 21.

Aspect 31 is an apparatus for wireless communication at a second device, comprising means for performing each step in the method of any of aspects 15 to 21.

Aspect 32 is the apparatus of any of aspects 28 to 31, further comprising a transceiver configured to receive or to transmit in association with the method of any of aspects 15 to 21.

Aspect 33 is a computer-readable medium storing computer executable code at a second device, the code when executed by at least one processor causes the at least one processor to perform the method of any of aspects 15 to 21.

What is claimed is:

1. An apparatus for wireless communication at a first device, comprising:
at least one memory; and
at least one processor coupled to the at least one memory and, based at least in part on stored information that is stored in the at least one memory, the at least one processor, individually or in any combination, is configured to:
transmit an indication of capability information of the first device to support data storage associated with non-causal demodulation reference signal (DMRS) combining across multiple slots; and
receive a communication after transmission of the indication of the capability information.

2. The apparatus of claim 1, wherein the indication of the capability information is included in one or more of radio resource control (RRC) signaling or a medium access control-control element (MAC-CE); and
wherein the indication indicates a maximum amount of the data storage that the first device supports for the non-causal DMRS combining.

3. The apparatus of claim 1, wherein to receive the communication, the at least one processor is further configured to:
perform a one-shot channel estimation based on a combination of each DMRS transmission across the multiple slots;
store data included in at least one slot of the multiple slots of the communication until the one-shot channel estimation is complete; and
demodulate the data based on the one-shot channel estimation.

4. The apparatus of claim 1, wherein an amount of the data storage is based on one or more of:
a time domain resource allocation for data symbols and a number of DMRS symbols in the multiple slots,
a frequency domain resource allocation for data transmission,
a DMRS configuration type and port indices in the multiple slots,
a number of data transmission layers,
a number of receive antennas, or
a number of transmission configuration indication (TCI) groups for multiple transmission and reception points.

5. The apparatus of claim 1, wherein the capability information indicates a maximum amount of the data storage that the first device supports as a maximum number of resources that the first device can store per receive antenna and per transmission layer before a data storage buffer is flushed, wherein the resources are based on one or more of a time domain, a frequency domain or a spatial domain.

6. The apparatus of claim 5, wherein the maximum amount of the data storage is indicated as a maximum number of time and frequency resource elements that the first device supports for storage before a need to flush a buffer.

7. The apparatus of claim 5, wherein the maximum amount of the data storage is based on a first number of data symbols, a second number of DMRS symbols and a total number of allocated resource blocks.

8. The apparatus of claim 1, further comprising:
at least one transceiver coupled to the at least one processor, wherein the at least one processor is further configured to:
transmit an additional indication of a minimum number of symbols between a DMRS symbol to be combined and an earliest feedback symbol across one or more of the multiple slots.

9. The apparatus of claim 1, wherein the at least one processor is further configured to:
transmit an additional indication of a minimum number of symbols between a control information in a last combinable slot and an earliest feedback symbol across one or more of the multiple slots.

10. The apparatus of claim 1, wherein the at least one processor is further configured to:
transmit an additional indication of a buffer capability for non-causal DMRS combining within a carrier aggregation capability, wherein the buffer capability is for combinations including one or more of bandwidth parts (BWPs) or component carriers (CCs).

11. The apparatus of claim 1, wherein the at least one processor is further configured to:
receive information indicating a total number of DMRS symbols that are combinable for one-shot channel estimation over two or more transmission time intervals (TTIs).

12. The apparatus of claim 11, wherein the information is comprised in control information in a slot for combining DMRS symbols across one or more subsequent slots.

13. The apparatus of claim 11, wherein the at least one processor is further configured to:
determine the total number of DMRS symbols to combine at the first device based on the information and one or more channel conditions.

14. An apparatus for wireless communication at a second device, comprising:
at least one memory; and
at least one processor coupled to the at least one memory and, based at least in part on stored information that is stored in the at least one memory, the at least one processor, individually or in any combination, is configured to:
receive an indication of capability information of a first device to support data storage associated with non-causal demodulation reference signal (DMRS) combining across multiple slots; and
transmit a communication for the first device after reception of the capability information.

15. The apparatus of claim 14, wherein the capability information indicates a maximum amount of the data storage that the first device supports as a maximum number of resources that the first device can store per receive antenna and per transmission layer before flush of a data storage buffer, wherein the resources are based on one or more of a time domain, a frequency domain or a spatial domain.

16. The apparatus of claim 15, wherein the maximum amount of the data storage is indicated as a maximum number of time and frequency resource elements that the first device supports for storage before a buffer is flushed.

17. The apparatus of claim 14, wherein the at least one processor is further configured to:
receive an additional indication of a minimum number of symbols between a DMRS symbol to be combined and an earliest feedback symbol across one or more of the multiple slots.

18. The apparatus of claim 14, wherein the at least one processor is further configured to:
receive an additional indication of a minimum number of symbols between a control information in a last combinable slot and an earliest feedback symbol across one or more of the multiple slots.

19. The apparatus of claim 14, wherein the at least one processor is further configured to:
receive an additional indication of a buffer capability for non-causal DMRS combining within a carrier aggregation capability, wherein the buffer capability is for combinations including one or more of bandwidth parts (BWPs) or component carriers (CCs).

20. The apparatus of claim 14, further comprising:
at least one transceiver coupled to the at least one processor, wherein the at least one processor is further configured to:
transmit information for the first device indicating a total number of DMRS symbols that are combinable for one-shot channel estimation over two or more transmission time intervals (TTIs).

21. A method of wireless communication at a first device, comprising:
transmitting an indication of capability information of the first device to support data storage associated with non-causal demodulation reference signal (DMRS) combining across multiple slots; and
receiving a communication after transmission of the indication of the capability information.

22. The method of claim 21, wherein the indication of the capability information is included in one or more of radio resource control (RRC) signaling or a medium access control-control element (MAC-CE); and
wherein the indication indicates a maximum amount of the data storage that the first device supports for the non-causal DMRS combining.

23. The method of claim 21, wherein receiving the communication includes:
performing a one-shot channel estimation based on a combination of each DMRS transmission across the multiple slots;
storing data included in at least one slot of the multiple slots of the communication until the one-shot channel estimation is complete; and
demodulating the data based on the one-shot channel estimation.

24. The method of claim 21, wherein the capability information indicates a maximum amount of the data storage that the first device supports as a maximum number of resources that the first device can store per receive antenna and per transmission layer before a data storage buffer is flushed, wherein the resources are based on one or more of a time domain, a frequency domain or a spatial domain.

25. The method of claim 21, further comprising:
transmitting an additional indication of a minimum number of symbols between a DMRS symbol to be combined and an earliest feedback symbol across one or more of the multiple slots.

26. The method of claim 21, further comprising:
transmitting an additional indication of a minimum number of symbols between a control information in a last combinable slot and an earliest feedback symbol across one or more of the multiple slots.

27. The method of claim 21, further comprising:
transmitting an additional indication of a buffer capability for non-causal DMRS combining within a carrier aggregation capability, wherein the buffer capability is for combinations including one or more of bandwidth parts (BWPs) or component carriers (CCs).

28. A method of wireless communication at a second device, comprising:
receiving an indication of capability information of a first device to support data storage associated with non-causal demodulation reference signal (DMRS) combining across multiple slots; and
transmitting a communication for the first device after reception of the capability information.

29. The method of claim 28 further comprising:
receiving an additional indication of a minimum number of symbols between a DMRS symbol to be combined and an earliest feedback symbol across one or more of the multiple slots.

30. The method of claim 28 further comprising:
receiving an additional indication of a minimum number of symbols between a control information in a last combinable slot and an earliest feedback symbol across one or more of the multiple slots.
